(19) United States
(12) Patent Application Publication
(10) Pub. No.: US 2002/0128998 A1
(43) Pub. Date: Sep. 12, 2002

(54) Automatic data explorer that determines relationships among original and derived fields

(76) Inventors: David Kil, Gilroy, CA (US); Brian Gregory, Mountain View, CA (US)

Correspondence Address: Doyle B. Johnson, Crosby, Heafey, Roach & May, 2 Embarcadero Center, Suite 2000, P. O. Box 7936, San Francisco, CA, 94120-7936, US

(21) Appl. No.: 09/858,927

(22) Filed: May 15, 2001

Related U.S. Application Data
(60) Provisional application No. 60/274,008, filed on Mar. 7, 2001.

(51) Int. Cl. G06F 7/00

(52) U.S. Cl. 707/1

(57) ABSTRACT

An automatic data mining tool that characterizes the relationships between different database fields from both structured and unstructured data. It extracts a data model, identifies and categorizes all the data fields, performs pre-processing to deal with unstructured data effectively, and processes the data without human intervention to automatically explore how the fields are related to one another. Prior to the commencement of user-controlled data mining, the present invention goes through all the fields in a database table space in order to establish meaningful relationships between various fields using whatever computer resources are available (i.e. by using “cycle stealing”). This allows the present invention to run in the background and establish relationships between fields even before data mining (DM) begins, and determine redundant, useless, and/or trivial fields without any external guidance. This results in faster, more accurate data mining since these relationships are available before a user begins the process of data mining.

### CROSS-REFERENCE TO RELATED APPLICATIONS

This application claims priority from U.S. Provisional Patent Application entitled IMPROVED DATA MINING APPLICATION, filed Mar. 7, 2001, Application Serial No. 60/274,008, the disclosure of which is herein incorporated by reference.

### BACKGROUND OF THE INVENTION

1. Field of the Invention

The present invention relates generally to the field of data mining, and more particularly to a system and method for automatic data exploration that determines relationships between original and derived fields.

2. Description of the Related Art

Data mining is inherently computation and memory intensive. Most data-mining (DM) software tools wait for the user to commence data mining. Only then, do they allow the user to explore data and obtain insights from the data using various techniques in an interactive mode. Furthermore, most DM tools lack procedures to deal with unstructured and hierarchical data. The unfortunate by-product of all these shortcomings is that the overall DM process can be long, tedious, and sometimes chaotic, resulting in the discovery of inadequate, inaccurate, and/or trivial information.

Riedel et al. “Data Mining on an OLTP System (Nearly) for Free,” Proc. 2000 ACM SIGMOD, pp. 13-21, May 2000, herein incorporated by reference, proposes a method for scheduling disk-access requests on an Online Transaction Processing (OLTP) system by taking advantage of the operating system's high-level functions to operate directly at individual disk drives so that additional job requests can be run when idle resources are available. However, the disclosed strategy is to piggyback interactive data-mining processes on transactional processes for a special system that uses Active Disks in an attempt to save hardware and maintenance costs for duplicate OLTP and decision support system (DSS) hardware (see Riedel et al. “Active Storage for Large-Scale Data Mining and Multimedia,” VLDB, August 1998, herein incorporated by reference). This solution does not address the importance of establishing and categorizing meaningful relationships between different database table fields in a seamless manner without requiring the use of special hardware.

Selfridge and Srivastava discuss a visual language for interactive data exploration in “A Visual Language for Interactive Data Exploration and Analysis,” Proc. IEEE Symposium on Visual Languages, Boulder, Colo., September 1996, herein incorporated by reference. This tool requires the user to work with data interactively in the areas of data segmentation, interpretation of statistics, SQL queries, and visualization.

Thus, there is a need for a data mining tool that provides improved performance and ease of use.

### SUMMARY OF THE INVENTION

In general, the present invention characterizes the relationships between different database table fields from both structured and unstructured data. It extracts a data model, identifies and categorizes all the data fields, performs pre-processing to deal with unstructured data effectively, and processes the data without human intervention to automatically explore how the fields are related to one another. It also determines which transformation space provides the most useful information using various signal processing algorithms.

Prior to the commencement of user-controlled data mining, the present invention goes through all the fields in a database table space in order to establish meaningful relationships between various fields using whatever computer resources are available (i.e. by using “cycle stealing”). This allows the present invention to run in the background and establish relationships between fields even before data mining (DM) begins, and determine redundant, useless, and/or trivial fields without any external guidance. This results in faster, more accurate data mining since these relationships are available before a user begins the process of data mining.

In one embodiment, the present invention is a method for improving the efficiency of data mining software tools that operate on a database, comprising determining relationships between tables in the database, identifying and categorizing all data fields in the tables, pre-processing any unstructured data fields to represent the unstructured fields with vectors compatible with a format of structured fields, determining a level of correlation, discrimination or association between all the data fields, and storing the correlation/discrimination/association data in a separate database, wherein the method is performed automatically by a computer system when system resources are available, and without human intervention.

The present invention may also be implemented as a method for determining relationships among data fields in a database, the method comprising extracting a data model for each set of related tables in the database, determining whether each field is structured or unstructured data, for each unstructured data field, determining whether the data is text, time-series or image data, (or other data types), extracting feature data from the unstructured data based upon whether the data is text, time-series or image data, analyzing the structured fields and feature data to determine a level of correlation, discrimination or association between the fields or data, and storing information related to the level of correlation/discrimination/association between the fields or data.

Portions of the present invention may be conveniently implemented using a conventional general purpose or a specialized digital computer or microprocessor programmed according to the teachings of the present disclosure, as will be apparent to those skilled in the computer art. Appropriate software coding can readily be prepared by skilled programmers based on the teachings of the present disclosure, as will be apparent to those skilled in the software art.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram of an automatic data explorer according to the present invention;

FIG. 2 illustrates the data relationship explorer block of FIG. 1 in further detail;

FIG. 3 is a diagram of a sample bank data table structure;

FIG. 4 is a flowchart of the processing steps of the data explorer, according to one embodiment of the present invention;

FIG. 5 is a graph of raw time series data;

FIG. 6 is a graph of the data of FIG. 5 transformed into the frequency domain to provide more useful information on the data; and

FIG. 7 illustrates an example of automatic data exploration using a magazine subscriber database.

### DETAILED DESCRIPTION OF THE INVENTION

The following description is provided to enable any person skilled in the art to make and use the invention and sets forth the best modes contemplated by the inventors for carrying out the invention. Various modifications, however, will remain readily apparent to those skilled in the art, since the basic principles of the present invention have been defined herein specifically to provide an automatic data explorer that determines relationships between original and derived fields. Any and all such modifications, equivalents and alternatives are intended to fall within the spirit and scope of the present invention.

In general, the present invention characterizes the relationships between different database table fields from both structured and unstructured data. It extracts a data model, identifies and categorizes all the data fields, performs pre-processing to deal with unstructured data effectively, and processes the data without human intervention to automatically explore how the fields are related to one another. It also determines which domain space provides the most useful information using various signal processing algorithms.

Prior to the commencement of user-controlled data mining, the present invention goes through all the fields in a database table space in order to establish meaningful relationships between various fields using whatever computer resources are available (i.e. by using “cycle stealing”). This allows the present invention to run in the background and establish relationships between fields even before data mining (DM) begins, and determine redundant, useless, and/or trivial fields without any external guidance. This results in faster, more accurate data mining since these relationships are available before a user begins the process of data mining.

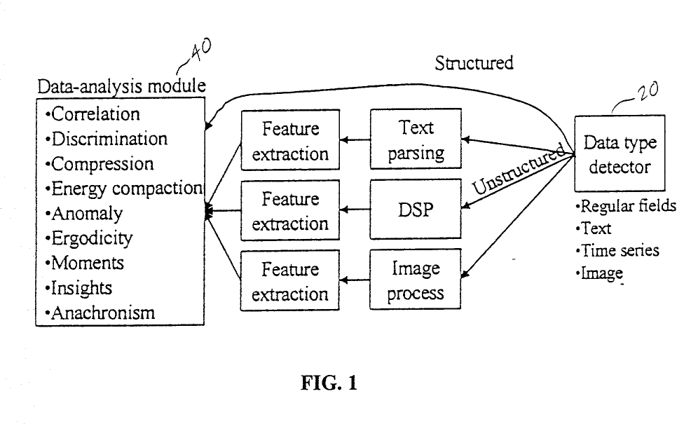

As illustrated in FIG. 1, a CPU/memory usage detector 10 runs in the background, constantly looking for resource availability. Whenever computing resources are available (block 12), a data model extractor 14 extracts the underlying data model for each set of tables with one-to-many and many-to-many relations in the data space 18. A data relationship explorer 16 explores relationships among the data fields scattered over multiple tables via entity-relationship models. The data-relationship explorer 16 first operates on each field separately, and then proceeds to multiple fields in combination.

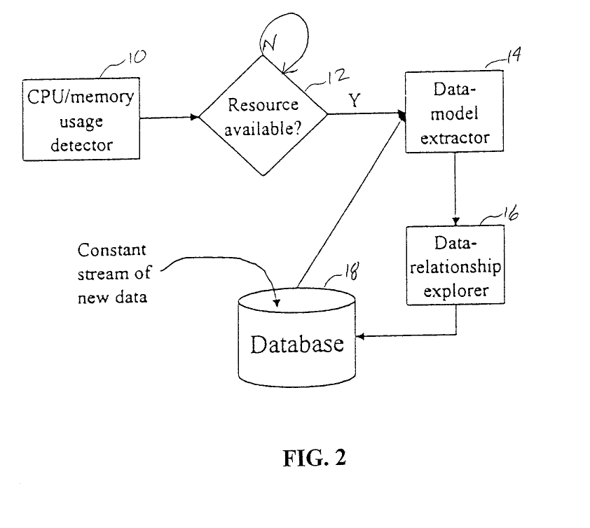

FIG. 2 illustrates the actual relationship-exploration modules. First, a data type detector 20 determines the data type of each field (i.e. text, boolean, etc.). Each field is categorized according to its data type. If the data type of a field is structured, i.e., a regular database field with a variable type other than binary large object (BLOB), the data-relationship explorer 16 proceeds directly to the data-analysis module 40 without any modification.

For unstructured data (BLOB), the data type detector 20 first determines if the data belongs to a text, time-series, or image class (or other data types which may be appropriate). For each class of unstructured data, there is a library of processing functions that extracts useful features from various transformation spaces. For instance, a time-series record goes through background normalization, wavelet scale-time representation, short-time Fourier transform time-frequency representation, and significant-event detection. Furthermore, data statistics can be computed in overlapping time intervals to detect anomalous events, estimate the level of ergodicity, and compute statistical moments. See, for example, David Kil and Frances Shin, Pattern Recognition and Prediction with Applications to Signal Characterization, Springer-Verlag, New York, 1996, herein incorporated by reference. In addition, the present invention may calculate the level of energy compaction achieved by a variety of data-transformation algorithms, such as linear prediction, the Fourier transform, local cosine transform, over-sampled Gabor transform, wavelets, etc. The same concept can be extended to a multi-dimensional space.

In one embodiment, the present invention partitions these computational operations for data relationship exploration into many small independent processing blocks so that each block can be completed during an available CPU time slot. This partitioning improves the computing-system response rate for the end user since whenever the user spawns a process, the background data-exploration job can quickly suspend its operation without having to reserve memory and CPU time for finishing up the current processing block. For each table space, a master script is automatically generated that schedules the sequencing, monitoring, and recording of the results of each small batch job.

Once the present invention represents BLOBs with vectors consistent with the format of the structured data, it then proceeds with correlation, discrimination and/or association analyses. The purposes of the correlation, discrimination and association analyses are to establish which variables are highly correlated (both linear and nonlinear), how these variables can be used to discriminate different outcomes in categorical fields, and how these variables are associated with one another in the sense of entropy or mutual information. See, for example, P. D'haeseleer, S. Liang, and R. Gomogyi, “Gene Expression Data Analysis and Modeling,” Pacific Symposium on Biocomputing, Hawaii, January, 1999, herein incorporated by reference. All of this information is stored in a pre-data mining data exploration database table for later use. The use of the pre-data mining data exploration database table speeds up the actual DM process, minimizes locking onto trivial knowledge, and fosters a more productive DM experience for the end user.

With this information stored prior to data mining, the present invention allows the data mining application to rapidly recommend a set of relevant input and output fields to use once the user specifies a problem to be solved. Furthermore, since most parameters in data exploration steps are already stored in the database, the response rate to the user's request during various data exploration steps is very fast, which is analogous to an increased cache hit ratio in memory storage devices.

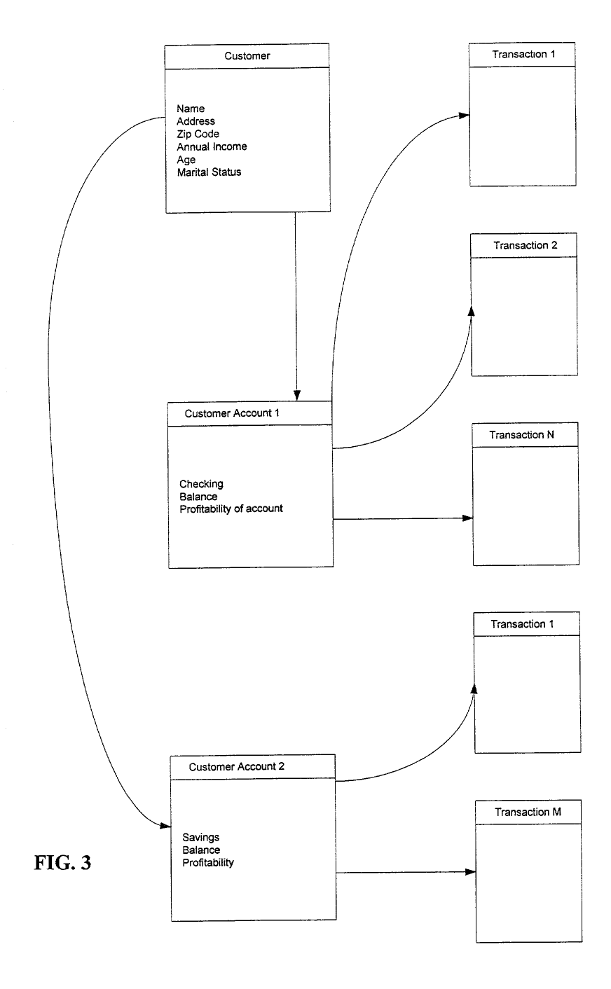

Consider the following example. As illustrated in FIG. 3, assume that there are three database tables for a major bank:

(1) Basic customer information, such as name, geneder, address, zip code, annual income, age, marital status, etc. (Customer table);

(2) Customer account information, such as checking, savings, investment brokerage, credit cards, mortgage, insurance, home equity loan, loan status (delinquent or not), profitability per account, etc. (Customer account table); and

(3) Historical transaction data for each account—loan payments, investment transactions, credit-card purchase records, etc. (Transaction table).

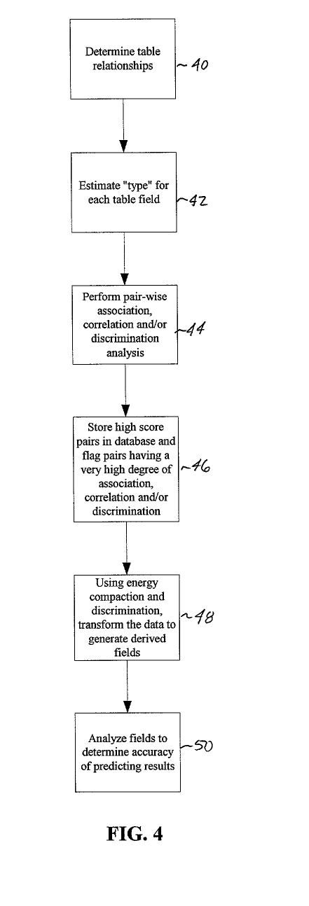

As shown in the flowchart of FIG. 4, the automatic data explorer according to the present invention first determines the table relationships and creates self-sufficient meta-data tables (block 40) (as described in related disclosure entitled HIERARCHICAL SUMMARIZATION AND VISUALIZATION OF A DATABASE TABLE WITH A MANY-TO-ONE RELATIONSHIP TO ANOTHER TABLE SO THE INFORMATION FROM MULTIPLE TABLES WITH ONE-TO-MANY RELATIONSHIPS CAN BE INCLUDED INTO DATA MINING, assignee docket number 00SC110, herein incorporated by reference). As illustrated in FIG. 3, the Customer table is the root node with the remaining two tables at the children nodes (i.e., each customer can have several accounts with each account having many transactional records). From the top (root or parent) to bottom (grandchild), the order is Customer→Customer account→Historical transaction.

The automatic data explorer then estimates the type of each table field (block 42). Structured data encompass fields, such as account information, annual income, mortgage balance, loan payment status, etc. Unstructured data include (1) free text, (2) time series, or (3) image data, typically stored as large text or binary large objects (BLOBs), or (4) fields at the lower hierarchy tables with many-to-one relations to the fields in their parent tables. For instance, transaction-related fields in the Transaction table are designated as time-series (i.e., although structured when viewed in isolation at its branch level) fields with irregular sampling intervals since they have many-to-one relations with the fields in the Customer account table. The transaction-related fields can be identified easily since they are usually associated with the corresponding time tag. Additional examples include a patient's medical history, a consumer's purchase history, loan payment history, etc.

The fields at the Customer and Customer account nodes are structured (no BLOBs) and categorized into significant and insignificant fields (address, birthday, name, SSN, etc.). If a field is significant, it is categorized into discrete (having a finite number of possibilities or categorical) or continuous. The continuous fields are also discretized as an alternate means of representation. Insignificant fields encompass not only meaningless ones (a primary-key field, for example) in the context of data mining, but also those that should be precluded based on privacy concerns, such as race, gender and SSN. Some fields may be converted into more meaningful fields. For example, a birthday field can be converted into an age field by subtracting the birthday from the current date.

For all the significant elements in the Customer and Customer-account tables, the automatic data explorer performs pair-wise correlation (continuous/continuous), discrimination (continuous/discrete or discrete/discrete), and association analyses (discrete/discrete) (block 44). Correlation analysis includes both linear and nonlinear methods so that even nonlinear correlation properties can be detected. Field pairs with significant correlation, discrimination or association scores are entered into a separate database for later retrieval when the end user commences data mining (block 46). By virtue of stringing highly correlated field pairs, the present invention can identify an arbitrary number of fields that show a high degree of correlation (discrimination or association). The field pairs with an unusually high degree of association, correlation or discrimination will be flagged for careful examination by the end user to see if they represent redundant fields or trivial knowledge. This step can save countless hours in data mining. For example, finding that annual income is related to purchasing power is generally not too interesting.

The automatic data explorer looks for additional meaningful relationships between the fields in the Transaction table and the fields in the other two tables. It has already categorized the fields in the Transaction table (child node) as time series data. Now it applies various signal processing and statistical summarization techniques to find an appropriate set of representational spaces without user intervention. The two criteria for selecting the appropriate transform space are energy compaction and discrimination (block 48).

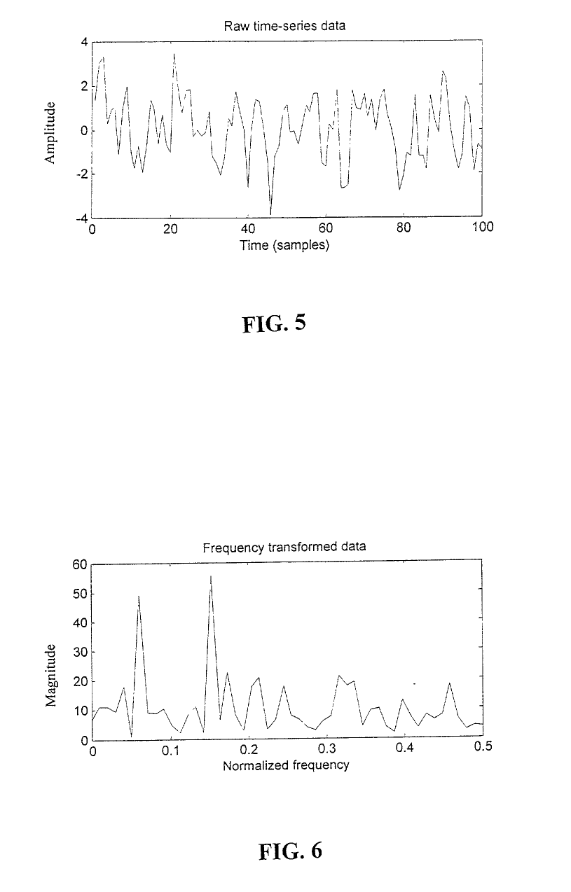

The energy compaction criterion is conceptually similar to data compression. FIG. 5 illustrates a simple example. The characteristics of the entire time-series data can be captured with two frequency bins in the frequency-transformed data, as shown in FIG. 6. As a general rule, the less the number of bits required to encode the original information in the transformed space, the better the transformation.

The discrimination criterion states that if the information derived from the frequency space is useful in differentiating various outcomes of a dependent variable, then the transformation of the original time-series data into the frequency space is a useful operation that extracts the relevant information in the context of data mining. That is, not only should the derived fields extracted from the frequency transformation space be compact, they must be able to discriminate different outcomes with relative ease. The same comment applies to correlation, if the target field is continuous.

For instance, customers with a high portfolio turnover rate can be identified using frequency analysis of their transactional records (i.e. a derived field created by applying signal processing to transactional records). Next, the automatic data explorer can divide customers with online brokerage accounts into active and inactive trade categories by generating a histogram of frequency-analysis results and discretizing the histogram output space into two halves. All the pertinent fields in the two parent tables are analyzed in terms of how accurately they can separate active trading accounts from inactive ones. For instance, is annual income a good indicator for predicting transactional behavior? How about a combination of annual income, size of all the assets with the bank, age, and education in predicting the same behavior? (block 50).

Once this analysis is complete, the automatic data explorer knows which fields are useful in predicting the brokerage customer's transactional behavior. This a priori knowledge will save time when a data mining analyst wants to identify cross-sell opportunities for brokerage accounts since the automatic data explorer already knows enough about useful fields that can be used to identify potential customers who are ideal candidates for opening brokerage accounts and generating trading profits for the bank (a new customer profile for a marketing campaign).

Moreover, trend analysis on the transactional time-series data can reveal numerous insights. The entire time series can be divided into overlapping frames (i.e., month or quarter). From each frame, digital signal processing (DSP) features, such as wavelet sub-band characteristics, regression coefficients, and inflection points, are extracted to characterize the customer behavior during the frame. For each frame, a dependent variable of interest can be appended. The dependent variable can be the customer profitability in the future (remember this is historical data, which allows the explorer to perform this type of trend analysis and prediction using historical data). That is, the problem being formulated here is that given the customer's recent transactional records, can one predict how profitable the customer will be in the near future?

If a customer currently profitable to the bank is about to become unprofitable, the bank can devise an experiment, where several promotional strategies can be evaluated for effectiveness. The actual effectiveness results can be incorporated back into the model for fine-tuning, all without human intervention. This kind of timely and appropriate intervention by the bank can prevent the customer from defecting to another bank. That is, the use of the automatic data explorer facilitates experimental design and timely decision making by virtue of making relevant information available before data mining commences.

In essence, the automatic data explorer hypothesizes all these scenarios and estimates their likelihoods whenever computing resources are available with no human intervention. Any discovered meaningful relationships will be presented to the end user during interactive data mining, so that feedback from the end user will improve the strength and accuracy of the automatic data explorer through continuous learning. For instance, the user can specify potential target variables, clustering variables (segmented data mining), and tables of interest prior to the commencement of data mining and let the data mining engine sift through data to find interesting patterns on its own. This additional constraint limits the search space, thereby reducing the computational requirements and speeding up the autonomous knowledge-discovery process.

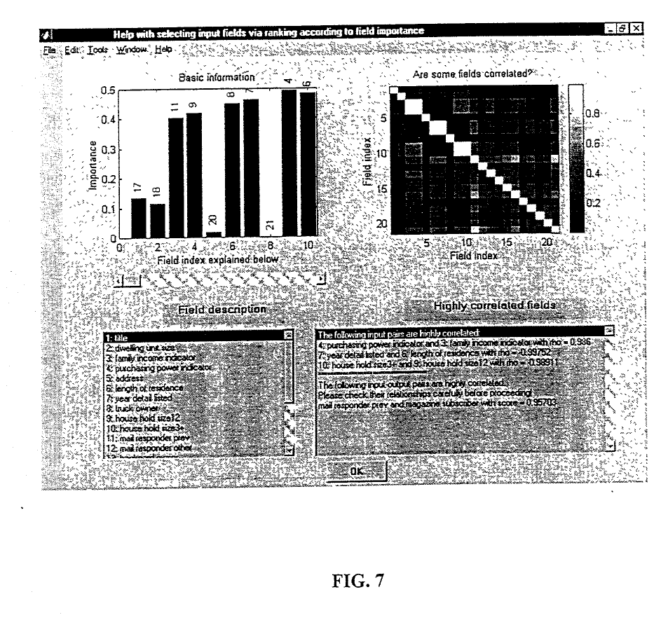

FIG. 7 illustrates an example of data exploration for predicting whether a person is a likely magazine subscriber, given a number of input features. Not only does the automatic data explorer identify highly redundant input files, but it also alerts the user of the possibility of trivial or redundant fields that are “too correlated” with the target variable. In this case, a person who has responded to a previous mailing campaign is likely to be a magazine subscriber, thus correlating these fields results in trivial knowledge.

As shown in FIG. 7, the input fields are ranked automatically based on their importance to predicting the variable (upper left plot). Furthermore, the data-exploration algorithm identifies highly correlated input fields (for instance, family income indicator and purchasing power), as well as those that are too good to be true in terms of predicting the magazine subscriber.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMs, microdrive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, requesting web pages, serving web pages, including html pages, Java applets, and files, establishing socket communications, formatting information requests, formatting queries for information from a probe device, formatting SMNP messages, and the display, storage, or communication of results according to the processes of the present invention.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method for improving the efficiency of data mining software tools that operate on a database, the method comprising:
determining relationships between tables in the database;
identifying and categorizing all data fields in the tables;
pre-processing any unstructured data fields to represent the unstructured fields with vectors compatible with a format of structured fields;
converting certain fields into modified fields;
determining a level of relationship between all the data fields; and
storing the relationship data in a database;
wherein the method is performed automatically by a computer system when system resources are available, and without human intervention.

2. The method of claim 1, wherein determining a level of relationship comprises determining one of a level of correlation, discrimination and association.

3. The method of claim 1, wherein determining a level of relationship comprises determining a level of correlation, discrimination and association.

4. A method for determining relationships among data fields in a database, the method comprising:
extracting a data model for each set of related tables in the database;
determining whether each field in each table is structured or unstructured data;
for each unstructured data field, determining a data type for each field;
extracting feature data from the unstructured data based upon the determined data type of the data fields;
analyzing the structured fields and feature data to determine a level of relationship between the fields or data; and
storing information related to the level of relationship between the fields or data.

5. The method of claim 4, wherein determining a level of relationship comprises determining one of a level of correlation, discrimination and association.

6. The method of claim 4, wherein determining a level of relationship comprises determining a level of correlation, discrimination and association.

7. The method of claim 4, wherein the method is performed on the database data prior to a user commencing a data mining operation.

8. The method of claim 7, wherein the method is performed automatically by a computer system when system resources are available.

9. The method of claim 8, wherein analyzing the structured fields and feature data further comprises performing one of compression, energy compaction, anomaly, ergodicity, moments, insights and anachronism analysis.

10. The method of claim 9, wherein extracting feature data comprises performing a mathematical transform on the unstructured data.

11. A computer readable medium including computer code for an automatic data explorer that determines relationships among original and derived fields, the computer readable medium comprising:
computer code for extracting a data model for each set of tables in the database;
computer code for determining whether each field is structured or unstructured data;
computer code for determining a data type for each unstructured field;
computer code for extracting feature data from the unstructured data based upon the determined data type of the data fields;
computer code for analyzing the structured fields and feature data to determine a level of relationship between the fields or data; and
computer code for storing information related to the level of relationship between the fields or data..

12. The computer readable medium of claim 11, wherein the computer code for determining a level of relationship comprises computer code for determining one of a level of correlation, discrimination and association.

13. The computer readable medium of claim 11, wherein the computer code for determining a level of relationship comprises computer code for determining a level of correlation, discrimination and association.

14. A computer system for improving the efficiency of data mining software tools that operate on a database, the computer system comprising:
a processor; and
computer program code that executes on the processor, the computer program code comprising:
computer code for determining relationships between tables in the database;
computer code for identifying and categorizing all data fields in the tables;
computer code for pre-processing any unstructured data fields to represent the unstructured fields with vectors compatible with a format of structured fields;
computer code for determining a level of relationship between the all the data fields, and
computer code for storing the relationship data in a database;
wherein the computer code is executed automatically by the computer system when system resources are available, and without human intervention..

15. The computer system of claim 14, further comprising computer code for converting certain fields into modified fields, prior to determining a level of relationship between all the data fields.

16. The computer system of claim 14, wherein the computer code for determining a level of relationship comprises computer code for determining one of a level of correlation, discrimination and association.

17. The computer system of claim 14, wherein the computer code for determining a level of relationship comprises computer code for determining a level of correlation, discrimination and association.
